(19) United States
(12) Patent Application Publication
(10) Pub. No.: US 2012/0020219 A1
(43) Pub. Date: Jan. 26, 2012

(54) Network system and congestion control method

(75) Inventors: Satoshi Kamiya, Tokyo (JP); Kiyohisa Ichino, Tokyo (JP)

(73) Assignee: NEC Corporation, Tokyo (JP)

(21) Appl. No.: 13/200,751

(22) Filed: Sep. 30, 2011

Related U.S. Application Data
(63) Continuation of application No. PCT/JP2011/051454, filed on Jan. 26, 2011.

(30) Foreign Application Priority Data
Feb. 12, 2010 (JP) 2010-029243

(51) Int. Cl. H04L 12/26

(52) U.S. Cl. 370/235

(57) ABSTRACT

A transmission terminal has a plurality of congestion control units (RPs) each controlling a frame transmission rate. A switch arranged between the transmission terminal and a reception terminal has a plurality of congestion detection units (CPs) each generating a congestion information notification frame addressed to the transmission terminal. A plurality of routes exist between the transmission terminal and the reception terminal. The management computer manages a correspondence relationship between the routes and the RPs, assigns any of the routes to a flow, selects a RP associated with a route assigned to the flow, and notifies the transmission terminal and the switch of the flow and the selected RP. When the switch receives a frame belonging to the flow, a CP associated with the selected RP generates the congestion information notification frame addressed to the selected RP. The transmission terminal transmits a frame belonging to the flow through the selected RP.

### CROSS-REFERENCE TO RELATED APPLICATION

This is a continuation of International Application No. PCT/JP2011/051454, filed on Jan. 26, 2011.

### TECHNICAL FIELD

The present invention relates to a congestion control technique in a network system.

### BACKGROUND ART

In recent years, a data center that integrates servers at one site and provides computer resources to individuals and companies has been increasingly used. The data center demands a network that connects a large number of servers while ensuring high-speed processing, low delay and low loss rate and has flexibility and extensibility in terms of connection.

In order to meet the above-mentioned demand, the IEEE802.1 settles on a plan on the “Data Center Bridging (DCB)” technique extending a conventional MAC bridge function. The IEEE802.1Qau is standardizing the “Congestion Notification (CN)” as one technical element of the DCB. Refer to Non-Patent Literature 1 for details of the IEEE802.1Qau. A congestion control method in the IEEE802.1Qau will be briefly described below.

FIG. 1 is a block diagram for describing the congestion control method in the IEEE802.1Qau. A transmission terminal 100-1 transmits a data frame 400 to a reception terminal 100-2. Switches 200-1, 200-2 are arranged in a network between the transmission terminal 100-1 and the reception terminal 100-2. Each switch 200 relays the data frame 400 and generates congestion information based on queue length information of an output queue directed toward the reception terminal 100-2. Then, the switch 200-1 (200-2) stores the congestion information in a congestion information notification frame 500-1 (500-2) and transmits the congestion information notification frame 500-1 (500-2) to the transmission terminal 100-1. The transmission terminal 100-1 controls a transmission rate of the data frame 400 based on the congestion information included in the received congestion information notification frames 500-1, 500-2. Specifically, the transmission terminal 100-1 decreases a frame transmission rate when occurrence of congestion is detected, and increases the frame transmission rate when it is determined that congestion is resolved.

In Non-Patent Literature 1 (“IEEE P802.1Qau/D2.2, Draft Standard for Local and Metropolitan Area Networks Virtual Bridged Local Area Networks, Amendment: Congestion Notification”, Jul. 23, 2009), a congestion detection point in each of the switches 200 is referred to as a “CP (Congestion Point)” and a congestion control point in the transmission terminal 100-1 is referred to as an “RP (Reaction Point)”. Also in the present specification, these terms “CP” and “RP” are appropriately used.

Patent Literature 1 (International Publication WO/2008/095010A1) describes a technique of managing a route in a network by means of a control server for controlling the network. When a frame with an unknown forwarding destination is inputted to a switch in the network, the switch inquires of the control server about a transfer route. In response to the inquiry, the control server sets forwarding information in all switches on the transfer route.

### CITATION LIST

### Patent Literature

Patent Literature 1: International Publication WO/2008/095010A1

### Non Patent Literature

Non-Patent Literature 1: “IEEEP802.1Qau/D2.2, Draft Standard for Local and Metropolitan Area Networks, Virtual Bridged Local Area Networks, Amendment: Congestion Notification”, Jul. 23, 2009.

### SUMMARY OF INVENTION

In a network system, a redundant circuit is generated for recovery from failures, traffic load distribution, or the like, and a data frame may be often transmitted to a same destination through a plurality of routes. However, in the case where the plurality of routes exist in the network, there is a possibility that congestion control as shown in FIG. 1 does not efficiently work.

For example, in a network system shown in FIG. 2, two routes 601 and 602 exist as routes from the transmission terminal 100-1 to the reception terminal 100-2. A first route 601 passes through switches 200-1, 200-2 and 200-3, and a second route 602 passes through switches 200-1, 200-4 and 200-3. Each of the switches 200 transmits the congestion information notification frame 500 including the congestion information to the transmission terminal 100-1.

Here, let us consider a case where the transmission terminal 100-1 has a single RP. For example, when congestion occurs in the route 601, the transmission terminal 100-1 decreases the frame transmission rate in order to relieve the congestion in the route 601. In this case, however, since there in only one RP, the frame transmission rate decreases also in the route 602 where no congestion is occurring. In other words, when different routes have different congestion states, the congestion control in one route has a negative effect on the data rate in the other route. This is inefficient.

The IEEE802.1Qau allows provision of a plurality of RPs in a terminal. Thus, for example, as shown in FIG. 2, a plurality of RPs (RP1, RP2) may be provided with respect to the plurality of routes 601 and 602, respectively. However, the IEEE802.1Qau does not specify how to decide a transmission route from the plurality of routes 601 and 602 and further to select one of the plurality of RPs, at transmission of the frame.

Moreover, the frame forwarding in the IEEE802.1Qau is based on a layer 2 (MAC) address. In the case of such frame forwarding, the transmission terminal 100-1 cannot distinguish the plurality of routes from each other. The reason is that both a combination of a source MAC address and a destination MAC address is the same regardless of the route. The transmission terminal 100-1 cannot select a suitable one from the plurality of RPs, based only on information on the source MAC address and the destination MAC address.

An object of the present invention is to provide a technique capable of performing efficient congestion control in a network system.

In an aspect of the present invention, a network system is provided. The network system has: a transmission terminal configured to transmit a frame toward a reception terminal; a switch arranged in a network between the transmission terminal and the reception terminal; and a management computer connected to the transmission terminal and the switch. The transmission terminal has a plurality of congestion control units. The switch has a plurality of congestion detection units respectively associated with the plurality of congestion control units. Each of the plurality of congestion detection units has a function of generating congestion information based on queue length information of an output queue directed toward the reception terminal and generating a congestion information notification frame that includes the generated congestion information and is addressed to the transmission terminal. Each of the plurality of congestion control units has a function of controlling, when receiving the congestion information notification frame, a frame transmission rate based on the congestion information included in the received congestion information notification frame. A plurality of routes exist between the transmission terminal and the reception terminal.

The management computer manages a correspondence relationship between the plurality of routes and the plurality of congestion control units, assigns any of the plurality of routes to a flow, selects a congestion control unit among the plurality of congestion control units that is associated with a route assigned to the flow, and notifies the transmission terminal and the switch of the flow and the selected congestion control unit. When the switch receives a frame belonging to the flow, a congestion detection unit associated with the selected congestion control unit among the plurality of congestion detection units generates the congestion information notification frame addressed to the selected congestion control unit. The transmission terminal transmits a frame belonging to the flow through the selected congestion control unit.

In another aspect of the present invention, a congestion control method in a network system is provided. The network system has: a transmission terminal configured to transmit a frame toward a reception terminal; and a switch arranged in a network between the transmission terminal and the reception terminal. The transmission terminal has a plurality of congestion control units. The switch has a plurality of congestion detection units respectively associated with the plurality of congestion control units. Each of the plurality of congestion detection units has a function of generating congestion information based on queue length information of an output queue directed toward the reception terminal and generating a congestion information notification frame that includes the generated congestion information and is addressed to the transmission terminal. Each of the plurality of congestion control units has a function of controlling, when receiving the congestion information notification frame, a frame transmission rate based on the congestion information included in the received congestion information notification frame. A plurality of routes exist between the transmission terminal and the reception terminal. The congestion control method according to the present invention includes: (A) managing a correspondence relationship between the plurality of routes and the plurality of congestion control units; (B) assigning any of the plurality of routes to a flow; (C) selecting a congestion control unit among the plurality of congestion control units that is associated with a route assigned to the flow; (D) notifying the transmission terminal and the switch of the flow and the selected congestion control unit; (E) generating, by a congestion detection unit associated with the selected congestion control unit among the plurality of congestion detection units in the switch receiving a frame belonging to the flow, the congestion information notification frame addressed to the selected congestion control unit; and (F) transmitting, by the transmission terminal, a frame belonging to the flow through the selected congestion control unit.

In still another aspect of the present invention, a management program which causes a computer to execute management processing for a network system is provided. The network system has: a transmission terminal configured to transmit a frame toward a reception terminal; and a switch arranged in a network between the transmission terminal and the reception terminal. The transmission terminal has a plurality of congestion control units. The switch has a plurality of congestion detection units respectively associated with the plurality of congestion control units. Each of the plurality of congestion detection units has a function of generating congestion information based on queue length information of an output queue directed toward the reception terminal and generating a congestion information notification frame that includes the generated congestion information and is addressed to the transmission terminal. Each of the plurality of congestion control units has a function of controlling, when receiving the congestion information notification frame, a frame transmission rate based on the congestion information included in the received congestion information notification frame. A plurality of routes exist between the transmission terminal and the reception terminal. The management processing according to the present invention includes: (a) managing a correspondence relationship between the plurality of routes and the plurality of congestion control units; (b) assigning any of the plurality of routes to a flow; (c) selecting a congestion control unit among the plurality of congestion control units that is associated with a route assigned to the flow; and (d) notifying the transmission terminal and the switch of the flow and the selected congestion control unit. When the switch receives a frame belonging to the flow, a congestion detection unit associated with the selected congestion control unit among the plurality of congestion detection units generates the congestion information notification frame addressed to the selected congestion control unit. The transmission terminal transmits a frame belonging to the flow through the selected congestion control unit.

According to the present invention, it is possible to perform efficient congestion control in the network system.

### BRIEF DESCRIPTION OF DRAWINGS

The above and other objects, advantages and features of the present invention will be more apparent from the following description of certain exemplary embodiments taken in conjunction with the accompanying drawings.

FIG. 1 is a block diagram for describing a congestion control method in the IEEE802.1Qau.

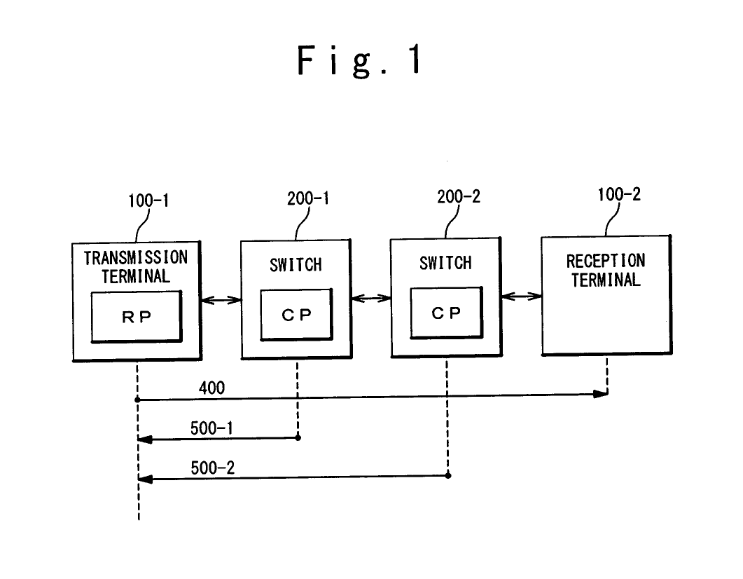

FIG. 2 is a block diagram for describing a problem of the congestion control method in the IEEE802.1Qau.

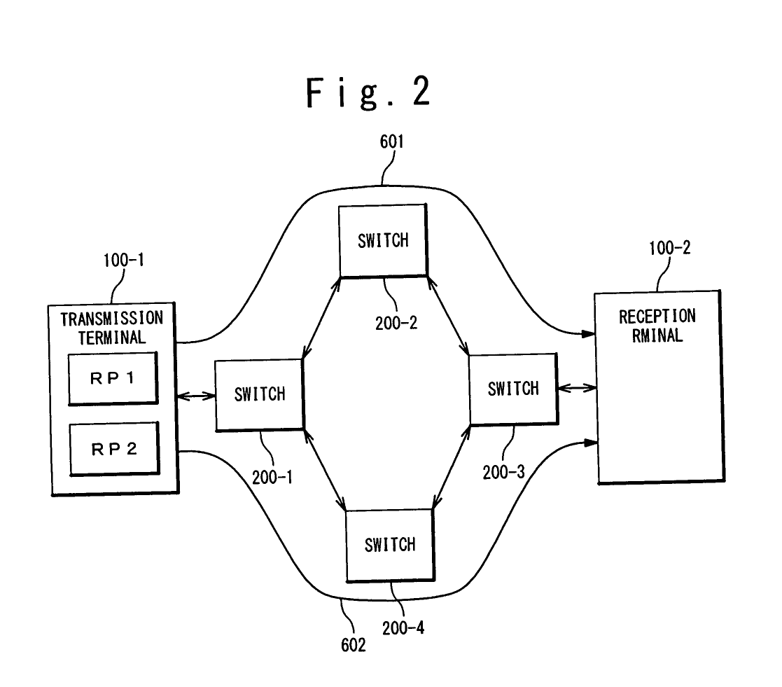

FIG. 3 is a block diagram schematically showing a configuration of a network system according to an exemplary embodiment of the present invention.

FIG. 4 is a block diagram for describing congestion control processing according to the present exemplary embodiment.

FIG. 5 is a conceptual diagram showing route RP correspondence information in the present exemplary embodiment.

FIG. 6 is a conceptual diagram showing an example of a flow information table in the present exemplary embodiment.

FIG. 7 is a conceptual diagram showing a flow RP correspondence table in the present exemplary embodiment.

FIG. 8 is a block diagram showing an example of a configuration of a network management server in the present exemplary embodiment.

FIG. 9 is a block diagram showing an example of a configuration of a terminal in the present exemplary embodiment.

FIG. 10 is a block diagram showing a modification example of a terminal in the present exemplary embodiment.

FIG. 11 is a block diagram showing an example of a configuration of a switch in the present exemplary embodiment.

FIG. 12 is a block diagram showing an example of a configuration of a switch in the present exemplary embodiment.

FIG. 13 is a block diagram showing a modification example of a switch in the present exemplary embodiment.

### DESCRIPTION OF EMBODIMENTS

Exemplary embodiments of the present invention will be described with reference to the attached drawings.

1. Summary

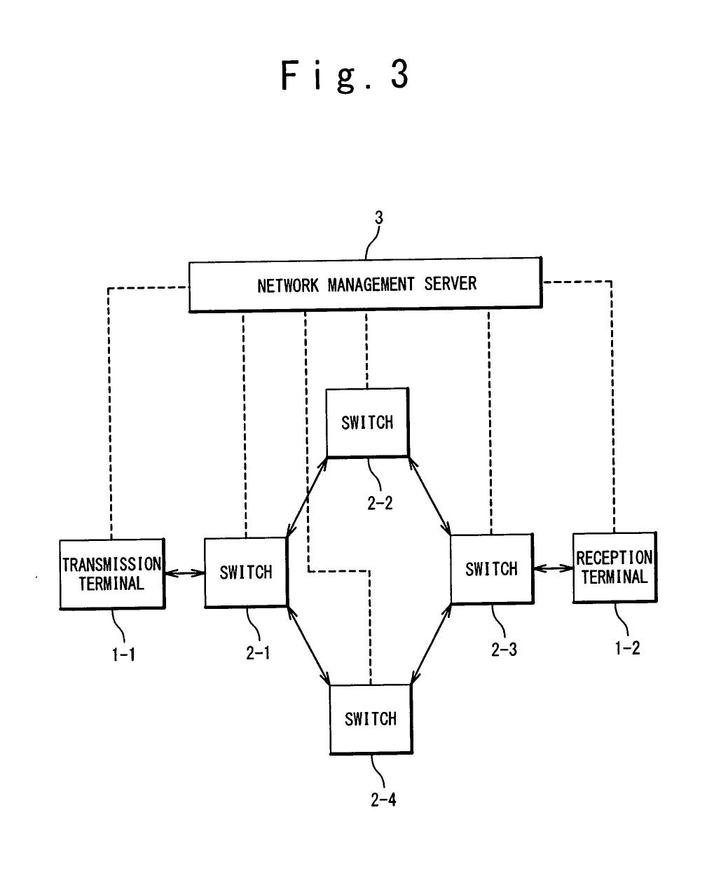

FIG. 3 is a block diagram schematically showing a configuration of a network system according to the present exemplary embodiment. The network system according to the present exemplary embodiment has a plurality of terminals 1, a plurality of switches 2 and a network management server 3 that are connected to a network.

The terminal 1 transmits and receives a data frame. Specifically, the plurality of terminals 1 includes a transmission terminal 1-1 and a reception terminal 1-2. The transmission terminal 1-1 transmits the data frame to the reception terminal 1-2. The reception terminal 1-2 receives the data frame transmitted from the transmission terminal 1-1.

The switch 2 has a frame forwarding function and relays the data frame between the transmission terminal 1-1 and the reception terminal 1-2. In FIG. 3, switches 2-1 to 2-4 are arranged in the network between the transmission terminal 1-1 and the reception terminal 1-2. The switch 2-1 is connected to the transmission terminal 1-1 and each of the switches 2-2 to 2-4 through data lines. The switch 2-3 is connected to the reception terminal 1-2 and each of the switches 2-2 and 2-4 through data lines. In this case, two routes exists from the transmission terminal 1-1 to the reception terminal 1-2. A first route passes through the switches 2-1, 2-2 and 2-3, and a second route passes through the switches 2-1, 2-4 and 2-3.

The network management server 3 is a management computer for managing and controlling the network system. The network management server 3 is connected to the terminals 1 and switches 2 through control links (expressed as broken lines in the figure). As described later, the network management server 3 provides the terminals 1 and the switches 2 with various information through the control links, thereby performing congestion control for the network system.

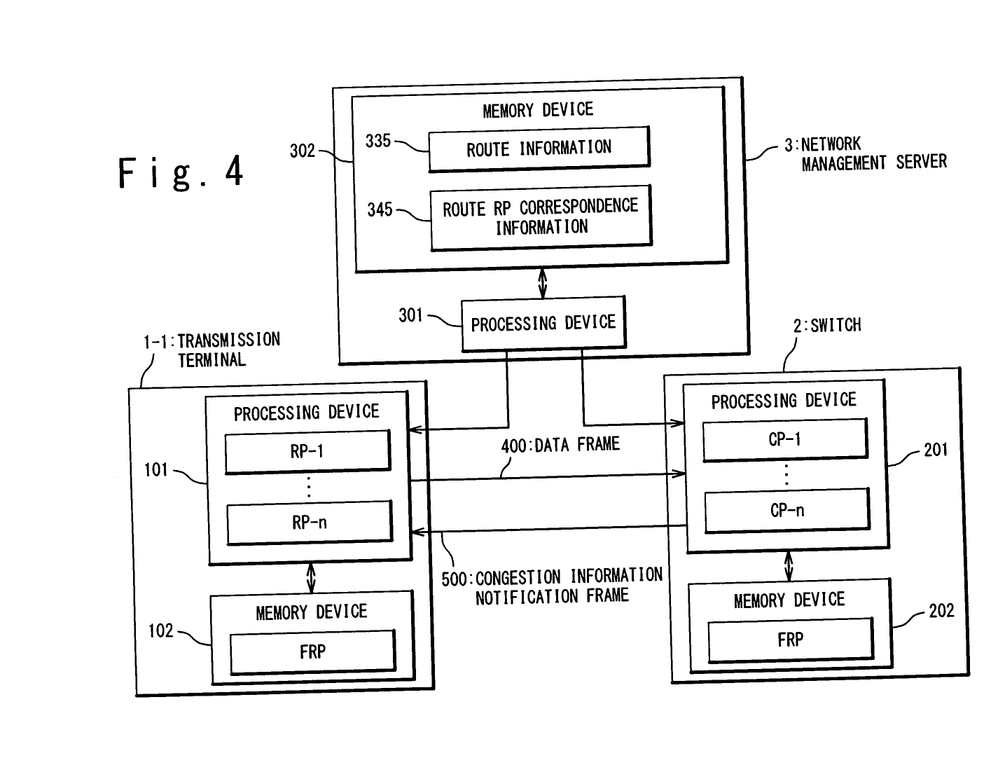

FIG. 4 is a block diagram showing congestion control processing according to the present exemplary embodiment. The transmission terminal 1-1 transmits a data frame 400 to the reception terminal 1-2. A flow consisting of the same type of data frames 400 is defined by a combination of parameters such as a source MAC address, a destination MAC address, a VLAN ID, a source IP address, a destination IP address, a source port number and a destination port number. Each flow can be distinguished based on header information of the data frame 400.

The switch 2 not only relays (forwards) the data frame 400 but also generates congestion information based on queue length information of an output queue directed toward the reception terminal 1-2. Then, the switch 2 stores the congestion information in a congestion information notification frame 500 and transmits the congestion information notification frame 500 to the transmission terminal 1-1. The transmission terminal 1-1 controls a transmission rate of the data frames 400 based on the congestion information included in the received congestion information notification frame 500. Specifically, the transmission terminal 1-1 decreases the frame transmission rate when occurrence of congestion is detected and increases the frame transmission rate when it is determined that congestion is resolved.

It should be noted that a congestion detection point (congestion detection unit) in each switch 2 is referred to as a “CP (Congestion Point)” and a congestion control point (congestion control unit) in the transmission terminal 1-1 is referred to as a “RP (Reaction Point)”.

In the present exemplary embodiment, the transmission terminal 1-1 has a plurality of RPs. The plurality of RPs are associated with a plurality of routes between the transmission terminal 1-1 and the reception terminal 1-2, respectively. Moreover, the switch 2 has a plurality of CPs. The plurality of CPs are associated with the plurality of routes between the transmission terminal 1-1 and the reception terminal 1-2, respectively. In other words, the plurality of RPs and the plurality of CPs are associated with each other. In an example shown in FIG. 4, the transmission terminal 1-1 has n RP-1 to RP-n and the switch 2 has n CP-1 to CP-n. Here, n is an integer equal to or more than 2.

The correspondence relationship between the plurality of RPs and the plurality of routes is managed by the network management server 3. More specifically, the network management server 3 has a processing device 301 and a memory device 302. The processing device 301 includes a CPU (Central Processing Unit) and executes various types of data processing. The memory device 302 includes a RAM (Random Access Memory) and an HDD (Hard Disk Drive) and stores various data.

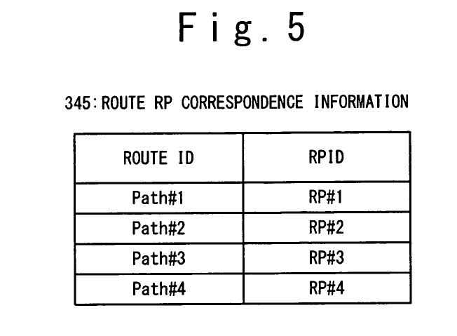

Information stored in the memory device 302 includes route information 335, route RP correspondence information 345 and the like. The route information 335 indicates the plurality of routes between the transmission terminal 1-1 and the reception terminal 1-2. The route RP correspondence information 345 indicates the correspondence relationship between the plurality of routes and the plurality of RPs. FIG. 5 conceptually shows the route RP correspondence information 345. In FIG. 5, the route RP correspondence information 345 indicates a correspondence relationship between a route identifier (hereinafter referred to as a “route ID”) and an RP identifier (hereinafter referred to as an “RPID”).

The processing device 301 manages the route information 335 and the route RP correspondence information 345. Moreover, the processing device 301 performs assignment of the route by reference to the route information 335. Specifically, in response to a request from the terminal 1 or the switch 2, the processing device 301 assigns any of the plurality of routes indicated by the route information 335 to a flow from the transmission terminal 1-1 to the reception terminal 1-2. Furthermore, the processing device 301 refers to the route RP correspondence information 345 to select an RP among the plurality of RPs that is associated with the route assigned to the flow. Then, the processing device 301 notifies the transmission terminal 1-1 and the switches 2 of information through the control links of the flow and the selected RP. The processing device 301 may further notify the transmission terminal 1-1 and the switches 2 through the control links of the route information 335.

It should be noted that the functions of the processing device 301 can be typically achieved by the processing device 301 executing a computer program (management program) stored in the memory device 302. The management program may be recorded on a computer-readable recording medium.

The transmission terminal 1-1 has a processing device 101 and a memory device 102. The processing device 101 includes a CPU and executes various types of data processing. The memory device 102 includes a RAM and an HDD and stores various data therein.

The processing device 101 receives the above-mentioned information on the flow and selected RP and the route information 335 from the network management server 3 through the control links. Then, the processing device 101 generates “flow RP correspondence information FRP” indicating a correspondence relationship between the flow and the selected RP which is notified from the network management server 3, and stores the flow RP correspondence information FRP in the memory device 102. Moreover, the processing device 101 updates the flow RP correspondence information FRP each time the correspondence relationship between the flow and the selected RP is notified.

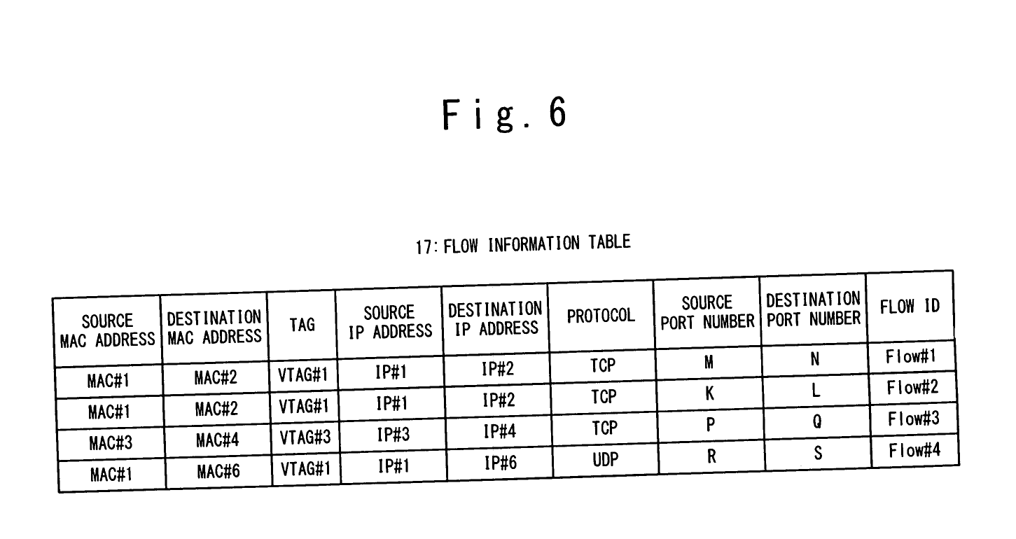

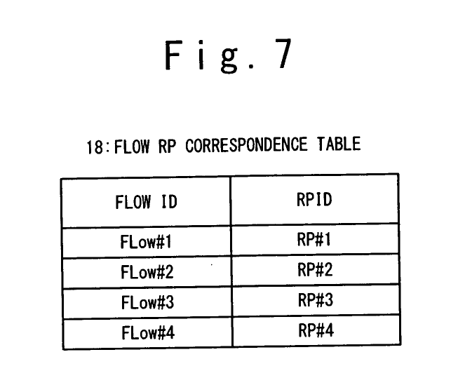

The flow RP correspondence information FRP includes, for example, a flow information table 17 as shown in FIG. 6 and a flow RP correspondence table 18 as shown in FIG. 7. The flow information table 17 indicates identification information of each flow (ex. combination of the source MAC address, the destination MAC address, the ULAN tag, the source IP address, the destination IP address, the protocol, the source port number and the destination port number) and an identifier of the flow (flow ID). The flow RP correspondence table 18 indicates a correspondence relationship between the flow ID and the RPID.

The processing device 101 further has the n RP-1 to RP-n. Each RP has a “congestion control function” that controls, when receiving a congestion information notification frame 500, a frame transmission rate based on the congestion information included in the congestion information notification frame 500.

According to the present exemplary embodiment, the processing device 101 executes the following processing when transmitting the data frame 400. That is, based on the flow RP correspondence information FRP, the processing device 101 recognizes the selected RP associated with a flow to which the transmission frame 400 belongs. Specifically, the processing device 101 searches the flow information table 17 (refer to FIG. 6) by using the header information of the transmission frame 400 as a search key and thereby obtains the flow ID of the flow to which the transmission frame 400 belongs. Furthermore, the processing device 101 searches the flow RP correspondence table 18 (refer to FIG. 7) by using the flow ID as a search key and thereby obtains the RPID associated with the flow ID. Then, the processing device 101 transmits the transmission frame 400 through the RP selected among the n RP-1 to RP-n. In this manner, independent congestion control with respect to each route can be achieved.

It should be noted that the functions of the processing device 101 can be typically achieved by the processing device 101 executing a computer program (terminal processing program) stored in the memory device 102. The terminal processing program may be recorded on a computer-readable recording medium.

The switch 2 has a processing device 201 and a memory device 202. The processing device 201 includes a CPU and executes various types of data processing. The memory device 202 includes an RAM and an HDD and stores various data therein.

The processing device 201 receives the above-mentioned information on the flow and selected RP and the route information 335 from the network management server 3 through the control links. Then, the processing device 201 generates “flow RP correspondence information FRP” indicating a correspondence relationship between the flow and the selected RP which is notified from the network management server 3, and stores the flow RP correspondence information FRP in the memory device 202. Moreover, the processing device 201 updates the flow RP correspondence information FRP each time the correspondence relationship between the flow and the selected RP is notified. The flow RP correspondence information FRP includes, for example, the flow information table 17 as shown in FIG. 6 and the flow RP correspondence table 18 as shown in FIG. 7.

The processing device 201 further has the n CP-1 to CP-n. Each CP has a “congestion detection function” that generates the congestion information based on queue length information (information of queue length) of the output queue directed toward the reception terminal 1-2 and generating the congestion information notification frame 500 including the generated congestion information. A destination of the congestion information notification frame 500 is the transmission terminal 1-1, and the generated congestion information notification frame 500 is transmitted from the processing device 201 to the transmission terminal 1-1.

According to the present exemplary embodiment, the processing device 201 executes the following processing when receiving the data frame 400 belonging to a certain flow. That is, the processing device 201 forwards the data frame 400 along a route designated by the network management server 3.

Further, based on the flow RP correspondence information FRP, the processing device 201 recognizes the selected RP associated with this flow. Specifically, the processing device 201 first searches the flow information table 17 (refer to FIG. 6) by using the header information of the data frame 400 as a search key and thereby obtains the flow ID of the flow to which the data frame 400 belongs. Furthermore, the processing device 201 searches the flow RP correspondence table 18 (refer to FIG. 7) by using the flow ID as a search key and thereby obtains the RPID associated with the flow ID. Then, the processing device 201 instructs a selected CP associated with the selected RP among the n CP-1 to CP-n to perform the congestion detection function. The selected CP generates the congestion information notification frame 500 that is addressed to the selected RP. The generated congestion information notification frame 500 is transmitted from the processing device 201 to the selected RP of the transmission terminal 1-1. In this manner, independent congestion detection with respect to each route can be achieved.

It should be noted that the functions of the processing device 201 can be typically achieved by the processing device 201 executing a computer program (switch processing program) stored in the memory device 202. The switch processing program may be recorded on a computer-readable recording medium.

According to the present exemplary embodiment, as described above, even when the plurality of routes exist between the transmission terminal 1-1 and the reception terminal 1-2, it is possible to achieve independent congestion detection and congestion control with respect to each route. The congestion information notification frames 500 relating to the respective routes are notified to the respectively associated source RPs without being mixed. As a result, it is possible to achieve efficient congestion control in the network system.

Moreover, according to the present exemplary embodiment, the correspondence relationship between the plurality of RPs and the plurality of routes is centralized managed by the network management server 3. Therefore, there is no need to modify an upper layer application that operates on the transmission terminal 1-1. In addition, an optimum route control in terms of the whole network can be achieved.

A specific example of a configuration of each element will be described below in detail.

2. Network Management Server

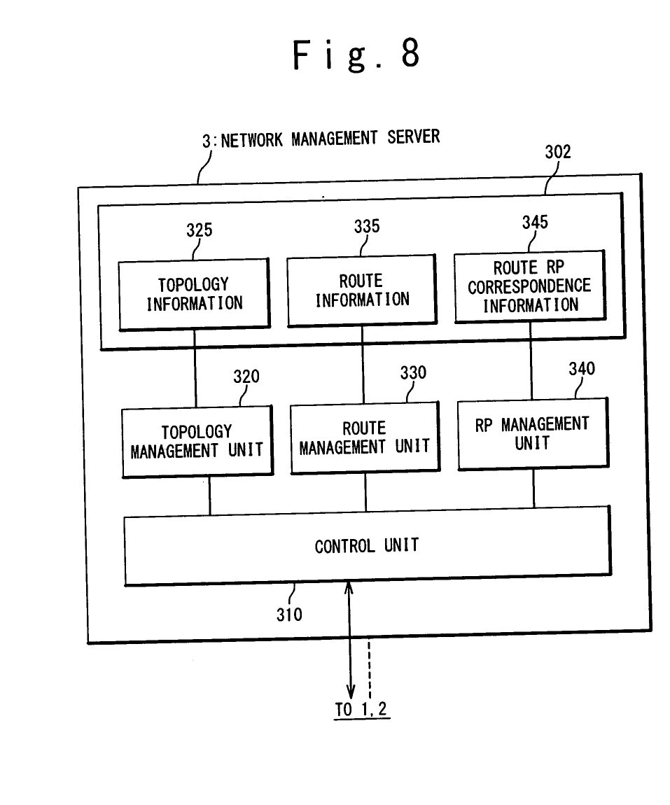

FIG. 8 is a block diagram showing an example of a configuration of the network management server 3 according to the present exemplary embodiment. The network management server 3 has a control unit 310, a topology management unit 320, a route management unit 330 and an RP management unit 340. These functional blocks are typically achieved by the processing device 301 executing a computer program (management program).

The topology management unit 320 generates topology information 325. The topology information 325 indicates a connection relationship in the network. That is, the topology information 325 indicates a connection relationship (topology) between components such as the terminals 1 and the switches 2. More specifically, the topology information 325 indicates which port of which component is connected to each port of each component. Examples of identification information of each component include a MAC address and an IP address. The topology management unit 320 stores the topology information 325 in the memory device 302 and manages the topology information 325.

The route management unit 330 calculates the plurality of routes between the terminals 1 based on the topology information 325 and generates the route information 335 indicating the plurality of routes. The route management unit 330 stores the route information 335 in the memory device 302 and manages the route information 335.

The RP management unit 340 associates the plurality of routes indicated by the route information 335 with the respective RPs and generates the route RP correspondence information 345 indicating the correspondence relationship between the plurality of routes and the plurality of RPs (refer to FIG. 5). The RP management unit 340 stores the route RP correspondence information 345 in the memory device 302 and manages the route RP correspondence information 345.

The control unit 310 refers to the route information 335 to assign the route. Specifically, in response to a request from the terminal 1 or the switch 2, the control unit 310 assigns any of the plurality of routes indicated by the route information 335 to a flow from the transmission terminal 1-1 to the reception terminal 1-2. Furthermore, the control unit 310 refers to the route RP correspondence information 345 to select an RP among the plurality of RPs that is associated with the route assigned to the flow. Then, the control unit 310 notifies the transmission terminal 1-1 and the switches 2 through the control links of information on the flow and the selected RP. The control unit 310 may further notify the transmission terminal 1-1 and the switches 2 through the control links of the route information 335.

3. Configuration and Operation of Terminal

3-1. Configuration

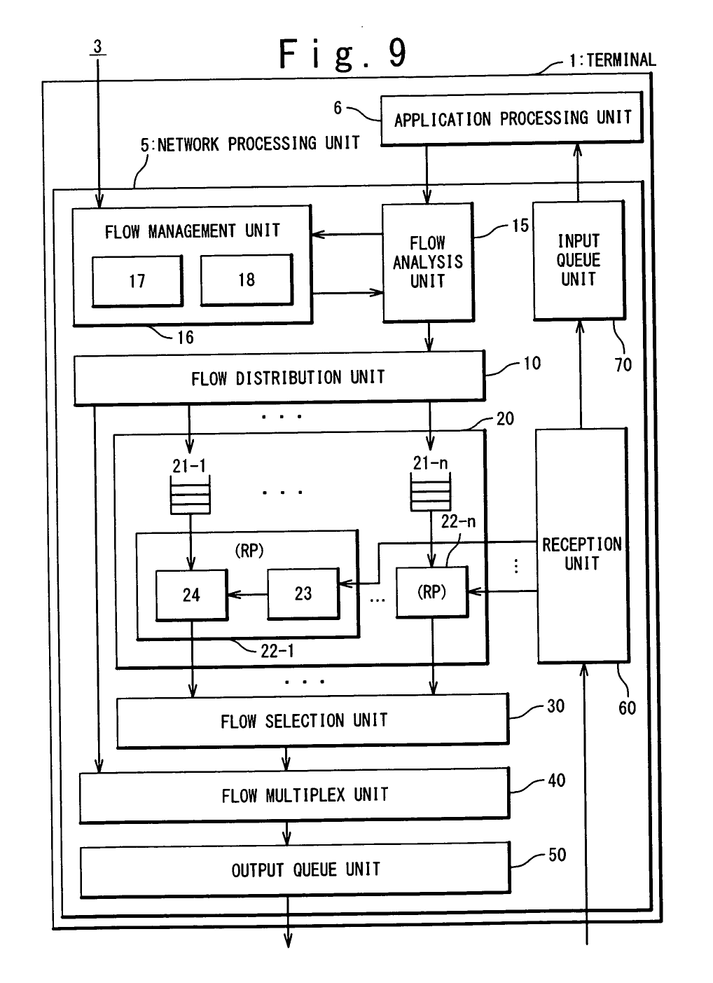

FIG. 9 is a block diagram showing an example of a configuration of the terminal 1 according to the present exemplary embodiment. The terminal 1 has a network processing unit 5 and an application processing unit 6. The application processing unit 6 performs application processing. The network processing unit 5 performs network processing. More specifically, the network processing unit 5 has a flow analysis unit 15, a flow management unit 16, a flow distribution unit 10, a flow control unit 20, a flow selection unit 30, a flow multiplex unit 40, an output queue unit 50, a reception unit 60 and an input queue unit 70.

The flow control unit 20 (Per-CNPV station function) includes a plurality of RP flow queues 21-1 to 21-n and a plurality of congestion control units 22-1 to 22-n. The plurality of congestion control units 22-1 to 22-n are associated with the plurality of RP flow queues 21-1 to 21-n, respectively. The plurality of congestion control units 22-1 to 22-n correspond to the above-described RP-1 to RP-n, respectively.

Each congestion control unit 22 (RP) has a state management unit 23 and a rate control unit 24. The state management unit 23 receives the congestion information notification frame 500 and manages the congestion state of the associated route based on the congestion information indicated by the congestion information notification frame 500. The rate control unit 24 controls the frame transmission rate in accordance with an instruction from the state management unit 23.

The flow management unit 16 serves as an input interface for the flow information and the selected RP information which are notified from the network management server 3. Moreover, the flow management unit 16 generates the above-mentioned flow RP correspondence information FRP (the flow information table 17 and the flow correspondence table 18) based on the flow information and the selected RP information which are notified from the network management server 3. The flow management unit 16 stores the flow RP correspondence information FRP in the memory device 102 and manages the flow RP correspondence information FRP. Furthermore, when receiving the flow identification information from the flow analysis unit 15, the flow management unit 16 refers to the flow correspondence information FRP and sends the RPID associated with the flow identification information back to the flow analysis unit 15.

The flow analysis unit 15 receives the data frame 400 from the application processing unit 6 and analyzes the data frame 400. Specifically, the flow analysis unit 15 extracts the header information from the data frame 400 and passes the header information as the flow identification information to the flow management unit 16. Then, the flow analysis unit 15 obtains the RPID associated with the flow identification information from the flow management unit 16. In this manner, the flow analysis unit 15 can recognize the selected RP associated with the flow to which the data frame 400 belongs. The flow analysis unit 15 passes the data frame 400 and the selected RPID to the flow distribution unit 10.

The flow distribution unit 10 receives the data frame 400 and the selected RPID from the flow analysis unit 15 and distributes the data frame 400. More specifically, the flow distribution unit 10 distributes the data frame 400 to the selected RP that is notified from the flow analysis unit 15. To this end, the flow distribution unit 10 outputs the data frame 400 to the RP flow queue 21 associated with the selected RP. It should be noted that a data frame 400 that is not a target of the congestion control is forwarded from the flow distribution unit 10 directly to the flow multiplex unit 40.

The flow selection unit 30 appropriately selects one to be transmitted from the data frames 400 outputted from the respective congestion control units 22-1 to 22-n and transmits the selected data frame 400 to the flow multiplex unit 40.

The flow multiplex unit 40 multiplexes the data frame 400 received directly from the flow distribution unit 10 and the data frame 400 received from the flow selection unit 30 and outputs the multiplexed data frame to the output queue unit 50.

The output queue unit 50 outputs the multiplexed data to the network.

The reception unit 60 receives a multiplexed data from the network and separates the multiplexed data. The reception unit 60 outputs the data frame 400 to the input queue unit 70. Whereas, the reception unit 60 forwards the congestion information notification frame 500 addressed to the selected RP to the selected RP. That is, the congestion information notification frame 500 is notified to the associated congestion control unit 22 (selected RP). It should be noted that the congestion information notification frame 500 having no target for notification is discarded.

The input queue unit 70 forwards the data frame 400 received from the reception unit 60 to the application processing unit 6.

3-2. Operation

<Operation with Respect to Information from Network Management Server 3>

Prior to transmission of the frame by the terminal 1, the flow management unit 16 receives the flow information and the selected RP information from the network management server 3. Based on the received flow information and selected RP information, the flow management unit 16 generates the above-mentioned flow RP correspondence information FRP (the flow information table 17 and the flow correspondence table 18). The flow management unit 16 stores the flow RP correspondence information FRP in the memory device 102 and manages the flow RP correspondence information FRP. Upon each reception of notification from the network management server 3, the flow management unit 16 updates the flow RP correspondence information FRP.

<Operation with Respect to Received Frame>

The reception unit 60 receives a congestion information notification frame 500 addressed to the selected RP which is transmitted from each switch 2 in the network. The reception unit 60 notifies the associated congestion control units 22 (selected RP) of the congestion information notification frame 500. The congestion information notification frame 500 having no target for notification is discarded. When receiving the congestion information notification frame 500, the state management unit 23 of the congestion control units 22 updates the congestion state of the associated route based on the congestion information indicated by the congestion information notification frame 500. In accordance with an instruction from the state management unit 23, the rate control unit 24 controls the frame transmission rate.

<Operation with Respect to Transmission Frame>

The application processing unit 6 outputs a data frame 400 to be transmitted to the network to the network processing unit 5. The flow analysis unit 15 receives the data frame 400 from the application processing unit 6. The flow analysis unit 15 extracts the header information from the data frame 400 and passes the header information as the flow identification information to the flow management unit 16.

The flow management unit 16 uses the flow identification information as a search key to search the flow RP correspondence information FRP (the flow information table 17 and the flow correspondence table 18). Thereby, the flow management unit 16 obtains the RPID (selected RP) associated with the flow identification information. The flow management unit 16 returns the RPID (selected RP) to the flow analysis unit 15.

The flow analysis unit 15 passes the data frame 400 and the selected RPID to the flow distribution unit 10. The flow distribution unit 10 distributes the data frame 400 to the selected RP notified from the flow analysis unit 15. To this end, the flow distribution unit 10 outputs the data frame 400 to the RP flow queues 21 associated with the selected RP. It should be noted that the data frame 400 that is not a target of the congestion control is forwarded from the flow distribution unit 10 directly to the flow multiplex unit 40.

Based on the congestion information indicated by the congestion information notification frame 500, each of the congestion control units 22-1 to 22-n (RP-1 to RP-n) controls the frame transmission rate. The flow selection unit 30 appropriately selects one to be transmitted from the data frames 400 outputted from the respective congestion control units 22-1 to 22-n and transmits the selected data frame 400 to the flow multiplex unit 40.

The flow multiplex unit 40 multiplexes the data frame 400 received directly from the flow distribution unit 10 and the data frame 400 received from the flow selection unit 30 and outputs the multiplexed data frame to the output queue unit 50. The output queue unit 50 outputs the multiplexed data to the network.

3-3. Modification Example

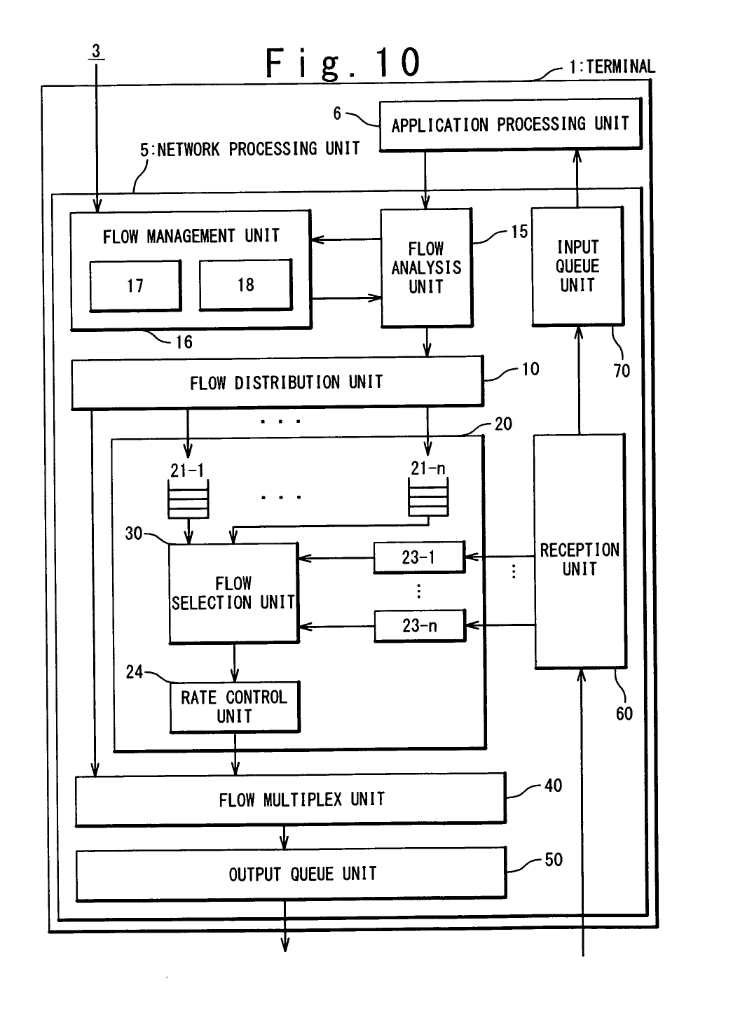

FIG. 10 is a block diagram showing a modification example of the terminal 1 according to the present exemplary embodiment. FIG. 10 is different from FIG. 9 in a configuration of the flow control unit 20. Specifically, in the present modification example, the flow control unit 20 has the plurality of RP flow queues 21-1 to 21-n, a plurality of state management units 23-1 to 23-n, one rate control unit 24 and one flow selection unit 30. The state management units 23-1 to 23-n are equivalent to the respective state management units 23 of the congestion control units 22-1 to 22-n in FIG. 9.

The flow selection unit 30 obtains the data frame 400 from the RP flow queues 21-1 to 21-n. Moreover, the flow selection unit 30 selects one associated with the data frame 400 from the plurality of state management units 23-1 to 23-n. Then, the flow selection unit 30 forwards the data frame 400 to the rate control unit 24 and also passes control information from the selected state management unit 23 to the rate control unit 24. In accordance with the control information, the rate control unit 24 controls the frame transmission rate.

According to the present modification example, a circuit size is reduced because the one rate control unit 24 is shared.

4. Configuration and Operation of Switch

4-1. Configuration

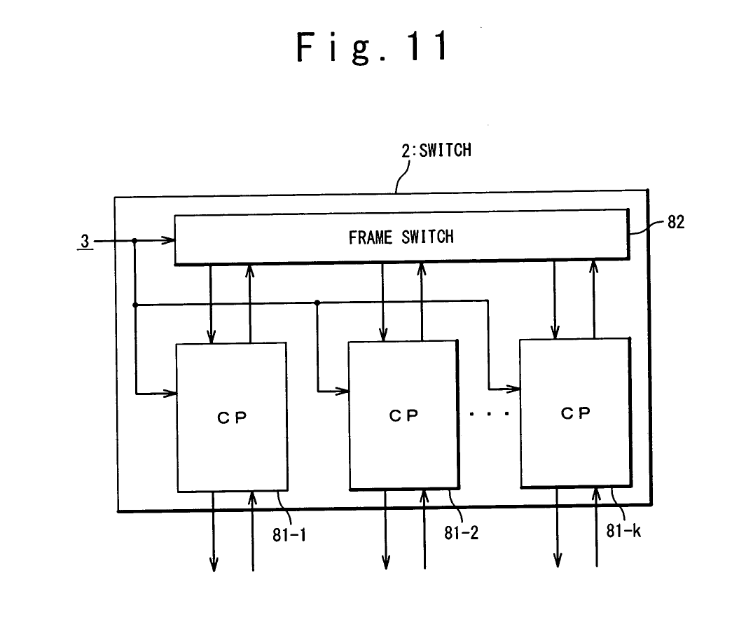

FIG. 11 is a block diagram showing an example of a configuration of the switch 2 according to the present exemplary embodiment. The switch 2 has a plurality of congestion detection units (CP) 81-l to 81k and a frame switch 82. The frame switch 82 has a function of forwarding a frame in accordance with the flow table set by the network management server 3. The data frame 400 inputted from an external network to a congestion detection unit 81-i (i is a natural number of l≦i≦k) is forwarded to the frame switch 82. Further, the data frame 400 is forwarded from the frame switch 82 to the congestion detection unit 81-j (j is a natural number of l≦j≦k) and then outputted to the external network.

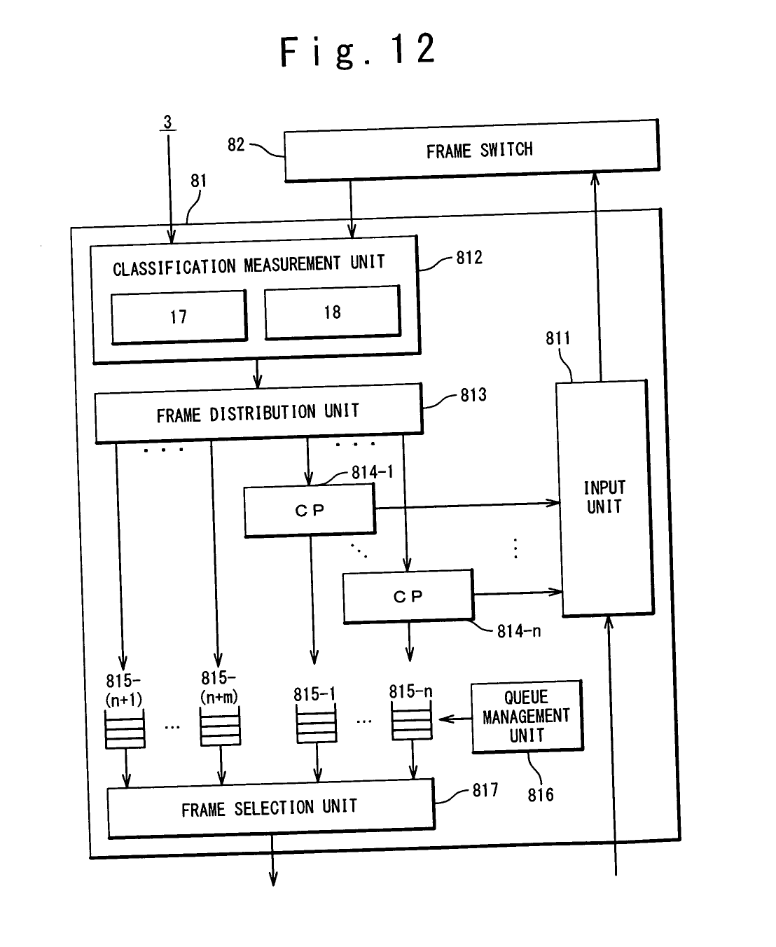

FIG. 12 shows in detail a configuration of one congestion detection unit 81. The congestion detection unit 81 has an input unit 811, a classification measurement unit 812, a frame distribution unit 813, n congestion detection units 814-1 to 814-n, (n+m) transmission frame queues 815-1 to 815-(n+m), a queue management unit 816 and a frame selection unit 817. Here, m is an integer equal to or more than 1. The n congestion detection units 814-1 to 814-n correspond to the above-mentioned CP-1 to CP-n, respectively.

The input unit 811 forwards the data frame 400 inputted from the external network to the frame switch 82.

When the congestion detection unit 814 makes a request to transmit the congestion information notification frame 500, the input unit 811 multiplexes the congestion information notification frame 500 and forwards the multiplexed frame to the frame switch 82.

The classification measurement unit 812 serves as an input interface for the flow information and the selected RP information which are notified from the network management server 3. Moreover, based on the flow information and the selected RP information which are notified from the network management server 3, the classification measurement unit 812 generates the above-mentioned flow RP correspondence information FRP (the flow information table 17 and the flow correspondence table 18). The classification measurement unit 812 stores the flow RP correspondence information FRP in the memory device 202 and manages the flow RP correspondence information FRP.

Furthermore, the classification measurement unit 812 receives a transfer frame from the frame switch 82 and classifies the transfer frame. Specifically, the classification measurement unit 82 extracts the header information from the transfer frame and uses the header information as the flow identification information to search the flow RP correspondence information FRP (the flow information table 17 and the flow correspondence table 18). Thereby, the classification measurement unit 82 can recognize the flow ID and the RPID of the flow to which the transfer frame belongs. The classification measurement unit 82 transmits the transfer frame, the flow ID and the RPID to the frame distribution unit 813. Moreover, the classification measurement unit 812 measures the number and size of classified transfer frames.

The frame distribution unit 813 receives the transfer frame, the flow ID and the RPID from the classification measurement unit 812. Based on the flow ID or the RPID, the frame distribution unit 813 stores the transfer frame in any of the transmission frame queues 815-1 to 815-(n+m). If the transfer frame is associated with the RPID as a target of congestion detection processing, the frame distribution unit 813 distributes the transfer frame to the congestion detection unit associated with the RPID among the congestion detection units 814-1 to 814-n. That is, the frame distribution unit 813 forwards the transfer frame to any of the transmission frame queues 815-1 to 815-n through one associated with the RPID among the congestion detection units 814-1 to 814-n.

The congestion detection units 814-1 to 814-n (CP-1 to CP-n) are provided associated with the transmission frame queues 815-1 to 815-n, respectively. Each of the congestion detection units 814-1 to 814-n generates congestion information based on the queue length information of the associated transmission frame queues 815 and transmits the congestion information notification frame 500 including the congestion information to the input unit 811.

The transmission frame queues 815-1 to 815-(n+m) stores the transfer frame outputted from the frame distribution unit 813. In response to a request from the frame selection unit 817, the transmission frame queues 815-1 to 815-(n+m) output the transfer frame.

The queue management unit 816 manages the transmission frame queues 815-1 to 815-(n+m).

The frame selection unit 817 reads the transfer frame from the transmission frame queues 815-1 to 815-(n+m) and outputs the transfer frame to the external network.

4-2. Operation

<Operation with Respect to Information from Network Management Server 3>

Prior to start of transmission of the frame by the switch 2, the classification measurement unit 812 receives the flow information and the selected RP information from the network management server 3. Based on the received the flow information and the selected RP information, the classification measurement unit 812 generates the above-mentioned flow RP correspondence information FRP (the flow information table 17 and the flow correspondence table 18). The classification measurement unit 812 stores the flow RP correspondence information FRP in the memory device 202 and manages the flow RP correspondence information FRP. Upon each reception of notification from the network management server 3, the classification measurement unit 812 updates the flow RP correspondence information FRP.

<Operation with Respect to Frame Reception from Network>

The input unit 811 of the congestion detection unit 81-i forwards the data frame 400 inputted from the external network to the frame switch 82. The frame switch 82 performs switching processing to output the transfer frame to the congestion detection unit 81-j. The classification measurement unit 812 of the congestion detection unit 81-j receives the transfer frame.

The classification measurement unit 812 extracts the header information from the transfer frame and uses the header information as the flow identification information to search the flow RP correspondence information FRP (the flow information table 17 and the flow correspondence table 18).

Thereby, the classification measurement unit 82 recognizes the flow ID and the RPID of the flow to which the transfer frame belongs. The classification measurement unit 82 transmits the transfer frame, the flow ID and the RPID to the frame distribution unit 813.

Based on the flow ID or the RPID, the frame distribution unit 813 stores the transfer frame in any of the transmission frame queues 815-1 to 815-(n+m). If the transfer frame is associated with the RPID as a target of the congestion detection processing, the frame distribution unit 813 forwards the transfer frame to any of the transmission frame queues 815-1 to 815-n through one associated with the RPID among the congestion detection units 814-1 to 814-n.

Each of the congestion detection units 814-1 to 814-n generates congestion information based on the queue length information of the associated transmission frame queue 815 and transmits the congestion information notification frame 500 including the congestion information to the input unit 811.

The frame selection unit 817 reads the transfer frame from the transmission frame queues 815-1 to 815-(n+m) and outputs the transfer frame to the external network.

4-3. Modification Example

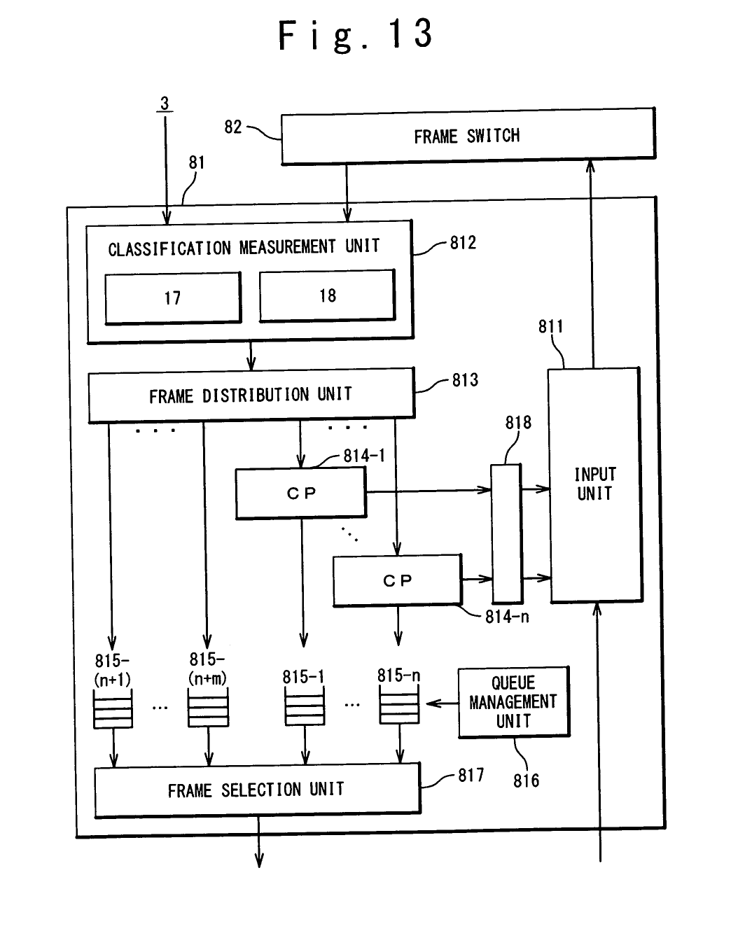

FIG. 13 is a block diagram showing a modification example of the switch 2 according to the present exemplary embodiment. In the present modification example, a congestion information calculation unit 818 is provided between the congestion detection units 814-1 to 814-n and the input unit 811. The congestion information calculation unit 818 has a function of generating the congestion information notification frame 500. In the present modification example, the congestion detection units 814-1 to 814-n notify the congestion information calculation unit 818 of queue length information of the respective transmission frame queues 815-1 to 815-n. Then, the congestion information calculation unit 818 generates the congestion information notification frame 500 based on the queue length information and transmits the generated congestion information notification frame 500 to the input unit 811.

According to the present modification example, a circuit size is reduced because the function of generating the congestion information notification frame 500 is shared.

5. Conclusion

According to the present exemplary embodiment, even in a network in which a plurality of transfer routes exist, the congestion notification method specified by the IEEE802.1Qau is effective. The reason is that the CPs and the RPs that are located on the respective routes are controlled and managed with respect to each route. The congestion information notification frames 500 relating to the respective routes are notified to the respectively associated RPs of the sources without being mixed. Thus, it is possible to perform efficient congestion control in the network system.

In addition, regarding the application operating on the terminal 1, there is no need to change existing software. The reason is that the network management server 3 determines which RP is used for the application operating on the terminal 1, and existence/absence of congestion control of IEEE802.1Qau is concealed to the application operating on the terminal 1.

Furthermore, in terms of use of the RP, total optimization can be easily achieved. Even if individual terminals attempt to achieve route optimization, the individual terminals have only partial information, so that route control does not necessarily achieve total optimization. On the contrary, when the network management server 3 can perform centralized management of topology and a load state of each switch 2, optimum route control can be calculated in terms of equation of traffic amount.

The present invention can be applied to prevent congestion in a wide-band and low-delay network environment such as a network in a data center, thereby providing the network environment with low loss rate.

While the exemplary embodiments of the present invention have been described above with reference to the attached drawings, the present invention is not limited to these exemplary embodiments and can be modified as appropriate by those skilled in the art without departing from the spirit and scope of the present invention.

While a part of or whole of the above-described exemplary embodiments may be described as the following Supplementary notes, it is not limited to that.

(Supplementary Note 1)

A network system comprising:
a transmission terminal configured to transmit a frame toward a reception terminal;
a switch arranged in a network between said transmission terminal and said reception terminal; and
a management computer connected to said transmission terminal and said switch,
wherein:
said transmission terminal comprises a plurality of congestion control units;
said switch comprises a plurality of congestion detection units respectively associated with said plurality of congestion control units;
each of said plurality of congestion detection units has a function of generating congestion information based on queue length information of an output queue directed toward said reception terminal and generating a congestion information notification frame that includes said generated congestion information and is addressed to said transmission terminal;
each of said plurality of congestion control units has a function of controlling, when receiving said congestion information notification frame, a frame transmission rate based on said congestion information included in said received congestion information notification frame;
a plurality of routes exist between said transmission terminal and said reception terminal;
said management computer manages a correspondence relationship between said plurality of routes and said plurality of congestion control units, assigns any of said plurality of routes to a flow, selects a congestion control unit among said plurality of congestion control units that is associated with a route assigned to said flow, and notifies said transmission terminal and said switch of said flow and said selected congestion control unit;
when said switch receives a frame belonging to said flow, a congestion detection unit associated with said selected congestion control unit among said plurality of congestion detection units generates said congestion information notification frame addressed to said selected congestion control unit; and
said transmission terminal transmits a frame belonging to said flow through said selected congestion control unit.

(Supplementary Note 2)

The network system according to Supplementary note 1,
wherein said management computer comprises:
a memory device in which route information indicating said plurality of routes and route RP correspondence information indicating the correspondence relationship between said plurality of routes and said plurality of congestion control units are stored; and
a processing device,
wherein:
said processing device refers to said route information to assign any of said plurality of routes to said flow; and
said processing device refers to said route RP correspondence information to select the congestion control unit among said plurality of congestion control units that is associated with the route assigned to said flow.

(Supplementary Note 3)

The network system according to Supplementary note 1 or 2,
wherein said transmission terminal further comprises:
a flow management unit configured to mange flow RP correspondence information indicating a correspondence relationship between said flow and said selected congestion control unit that is notified from said management computer;
a flow analysis unit configured to recognize, based on said flow RP correspondence information, said selected congestion control unit associated with the flow to which a transmission frame belongs; and
a flow distribution unit configured to distribute said transmission frame to said selected congestion control unit recognized by said flow analysis unit.

(Supplementary Note 4)

The network system according to any one of Supplementary notes 1 to 3,
wherein said switch further comprises:
a classification measurement unit configured to manage flow RP correspondence information indicating a correspondence relationship between said flow and said selected congestion control unit that is notified from said management computer; and
a frame distribution unit,
wherein:
said classification measurement unit refers to said flow RP correspondence information to recognize said selected congestion control unit associated with the flow to which a transfer frame belongs; and
said frame distribution unit distributes said transfer frame to said congestion detection unit associated with said selected congestion control unit.

(Supplementary Note 5)

A congestion control method in a network system,
wherein said network system comprises:
a transmission terminal configured to transmit a frame toward a reception terminal; and
a switch arranged in a network between said transmission terminal and said reception terminal,
wherein:
said transmission terminal comprises a plurality of congestion control units;
said switch comprises a plurality of congestion detection units respectively associated with said plurality of congestion control units;
each of said plurality of congestion detection units has a function of generating congestion information based on queue length information of an output queue directed toward said reception terminal and generating a congestion information notification frame that includes said generated congestion information and is addressed to said transmission terminal;
each of said plurality of congestion control units has a function of controlling, when receiving said congestion information notification frame, a frame transmission rate based on said congestion information included in said received congestion information notification frame; and
a plurality of routes exist between said transmission terminal and said reception terminal,
wherein said congestion control method comprises:
managing a correspondence relationship between said plurality of routes and said plurality of congestion control units;
assigning any of said plurality of routes to a flow;
selecting a congestion control unit among said plurality of congestion control units that is associated with a route assigned to said flow;
notifying said transmission terminal and said switch of said flow and said selected congestion control unit;
generating, by a congestion detection unit associated with said selected congestion control unit among said plurality of congestion detection units in said switch receiving a frame belonging to said flow, said congestion information notification frame addressed to said selected congestion control unit; and
transmitting, by said transmission terminal, a frame belonging to said flow through said selected congestion control unit.

(Supplementary Note 6)

A management program that causes a computer to execute management processing for a network system,
wherein said network system comprises:
a transmission terminal configured to transmit a frame toward a reception terminal; and
a switch arranged in a network between said transmission terminal and said reception terminal,
wherein:
said transmission terminal comprises a plurality of congestion control units;
said switch comprises a plurality of congestion detection units respectively associated with said plurality of congestion control units;
each of said plurality of congestion detection units has a function of generating congestion information based on queue length information of an output queue directed toward said reception terminal and generating a congestion information notification frame that includes said generated congestion information and is addressed to said transmission terminal;
each of said plurality of congestion control units has a function of controlling, when receiving said congestion information notification frame, a frame transmission rate based on said congestion information included in said received congestion information notification frame; and
a plurality of routes exist between said transmission terminal and said reception terminal,
wherein said management processing comprises:
managing a correspondence relationship between said plurality of routes and said plurality of congestion control units;
assigning any of said plurality of routes to a flow;
selecting a congestion control unit among said plurality of congestion control units that is associated with a route assigned to said flow; and
notifying said transmission terminal and said switch of said flow and said selected congestion control unit,
wherein:
when said switch receives a frame belonging to said flow, a congestion detection unit associated with said selected congestion control unit among said plurality of congestion detection units generates said congestion information notification frame addressed to said selected congestion control unit; and
said transmission terminal transmits a frame belonging to said flow through said selected congestion control unit.

This application is based upon and claims the benefit of priority from Japanese patent application No. 2010-029243, filed on Feb. 12, 2010, the disclosure of which is incorporated herein in its entirely by reference.

1. A network system comprising:
a transmission terminal configured to transmit a frame toward a reception terminal;
a switch arranged in a network between said transmission terminal and said reception terminal; and
a management computer connected to said transmission terminal and said switch,
wherein:
said transmission terminal comprises a plurality of congestion control units;
said switch comprises a plurality of congestion detection units respectively associated with said plurality of congestion control units;
each of said plurality of congestion detection units has a function of generating congestion information based on queue length information of an output queue directed toward said reception terminal and generating a congestion information notification frame that includes said generated congestion information and is addressed to said transmission terminal;
each of said plurality of congestion control units has a function of controlling, when receiving said congestion information notification frame, a frame transmission rate based on said congestion information included in said received congestion information notification frame;
a plurality of routes exist between said transmission terminal and said reception terminal;
said management computer manages a correspondence relationship between said plurality of routes and said plurality of congestion control units, assigns any of said plurality of routes to a flow, selects a congestion control unit among said plurality of congestion control units that is associated with a route assigned to said flow, and notifies said transmission terminal and said switch of said flow and said selected congestion control unit;
when said switch receives a frame belonging to said flow, a congestion detection unit associated with said selected congestion control unit among said plurality of congestion detection units generates said congestion information notification frame addressed to said selected congestion control unit; and
said transmission terminal transmits a frame belonging to said flow through said selected congestion control unit.

2. The network system according to claim 1,
wherein said management computer comprises:
a memory device in which route information indicating said plurality of routes and route RP correspondence information indicating the correspondence relationship between said plurality of routes and said plurality of congestion control units are stored; and
a processing device,
wherein:
said processing device refers to said route information to assign any of said plurality of routes to said flow; and
said processing device refers to said route RP correspondence information to select the congestion control unit among said plurality of congestion control units that is associated with the route assigned to said flow.

3. The network system according to claim 1,
wherein said transmission terminal further comprises:
a flow management unit configured to mange flow RP correspondence information indicating a correspondence relationship between said flow and said selected congestion control unit that is notified from said management computer;
a flow analysis unit configured to recognize, based on said flow RP correspondence information, said selected congestion control unit associated with the flow to which a transmission frame belongs; and
a flow distribution unit configured to distribute said transmission frame to said selected congestion control unit recognized by said flow analysis unit.

4. The network system according to claim 1,
wherein said switch further comprises:
a classification measurement unit configured to manage flow RP correspondence information indicating a correspondence relationship between said flow and said selected congestion control unit that is notified from said management computer; and
a frame distribution unit,
wherein:
said classification measurement unit refers to said flow RP correspondence information to recognize said selected congestion control unit associated with the flow to which a transfer frame belongs; and
said frame distribution unit distributes said transfer frame to said congestion detection unit associated with said selected congestion control unit.

5. A congestion control method in a network system,
wherein said network system comprises:
a transmission terminal configured to transmit a frame toward a reception terminal; and
a switch arranged in a network between said transmission terminal and said reception terminal,
wherein:
said transmission terminal comprises a plurality of congestion control units;
said switch comprises a plurality of congestion detection units respectively associated with said plurality of congestion control units;
each of said plurality of congestion detection units has a function of generating congestion information based on queue length information of an output queue directed toward said reception terminal and generating a congestion information notification frame that includes said generated congestion information and is addressed to said transmission terminal;
each of said plurality of congestion control units has a function of controlling, when receiving said congestion information notification frame, a frame transmission rate based on said congestion information included in said received congestion information notification frame; and
a plurality of routes exist between said transmission terminal and said reception terminal,
wherein said congestion control method comprises:
managing a correspondence relationship between said plurality of routes and said plurality of congestion control units;
assigning any of said plurality of routes to a flow;
selecting a congestion control unit among said plurality of congestion control units that is associated with a route assigned to said flow;
notifying said transmission terminal and said switch of said flow and said selected congestion control unit;
generating, by a congestion detection unit associated with said selected congestion control unit among said plurality of congestion detection units in said switch receiving a frame belonging to said flow, said congestion information notification frame addressed to said selected congestion control unit; and
transmitting, by said transmission terminal, a frame belonging to said flow through said selected congestion control unit.

6. A recording medium on which a management program is recorded,
wherein said management program causes a computer to execute management processing for a network system,
wherein said network system comprises:
a transmission terminal configured to transmit a frame toward a reception terminal; and
a switch arranged in a network between said transmission terminal and said reception terminal,
wherein:
said transmission terminal comprises a plurality of congestion control units;
said switch comprises a plurality of congestion detection units respectively associated with said plurality of congestion control units;
each of said plurality of congestion detection units has a function of generating congestion information based on queue length information of an output queue directed toward said reception terminal and generating a congestion information notification frame that includes said generated congestion information and is addressed to said transmission terminal;
each of said plurality of congestion control units has a function of controlling, when receiving said congestion information notification frame, a frame transmission rate based on said congestion information included in said received congestion information notification frame; and
a plurality of routes exist between said transmission terminal and said reception terminal,
wherein said management processing comprises:
managing a correspondence relationship between said plurality of routes and said plurality of congestion control units;
assigning any of said plurality of routes to a flow;
selecting a congestion control unit among said plurality of congestion control units that is associated with a route assigned to said flow; and
notifying said transmission terminal and said switch of said flow and said selected congestion control unit,
wherein:
when said switch receives a frame belonging to said flow, a congestion detection unit associated with said selected congestion control unit among said plurality of congestion detection units generates said congestion information notification frame addressed to said selected congestion control unit; and
said transmission terminal transmits a frame belonging to said flow through said selected congestion control unit.
